(19) United States
(12) Patent Application Publication
(10) Pub. No.: US 2021/0110237 A1
(43) Pub. Date: Apr. 15, 2021

(54) Computer Operations and Architecture for Artificial Intelligence Networks and Wave Form Transistor

(71) Applicant: Alexander D Haussmann, Lakewood, CO (US)

(72) Inventor: Alexander D Haussmann, Lakewood, CO (US)

(21) Appl. No.: 17/062,473

(22) Filed: Oct. 2, 2020

Related U.S. Application Data
(60) Provisional application No. 62/913,163, filed on Oct. 9, 2019.
(60) Provisional application No. 62/995,051, filed on Jan. 10, 2020.

(51) Int. Cl. G06N 3/04

(52) U.S. Cl. CPC G06N 3/04

(57) ABSTRACT

The nodes of an artificial intelligence neural network may be wave form transistors which signal one another using functions as well as real numbers. The nodes then perform a wide variety of functions, on the functions which they have received as input and then output results (functions) which become the signal to the next nodes in the net. The system utilizes multi-dimensional multi-variable functions. In addition to using functions as signals, the present invention teaches that the edges (connections) themselves may have function inputs influencing them, such that the function which is put into a connection (dendrite, synapse, edge, etc) may be altered during transmission in a way beyond merely being weighted or run through a function in the connection. The electronic version of the wave form transistor features multiple input leads which are under the influence of electro-magnets.

### STATEMENT REGARDING FEDERALLY FUNDED RESEARCH

This invention was not made under contract with an agency of the US Government, nor by any agency of the US Government.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### FIELD OF THE INVENTION

This invention relates generally to a new type of transistor and to improving operation of nodes of an artificial intelligence network and specifically to devices and methods of a new architecture of nodes.

### BACKGROUND OF THE INVENTION

The traditional artificial intelligence neural network is a group of artificial neurons or nodes having connections (or edges) between them. The nodes are often organized into layers, with the neurons of a single layer feeding signals to the neurons in the next layer. There are multiple connections from or to each neuron, mimicking the action of the dendrites of a real neuron.

In action, the actual operation of these devices is surprisingly simple. Each node acts as a summing engine, either simple summation or more complex. When its summation of input signals (from a signaling layer) reaches a given value the node trips to send one or more signals of its own to nodes in the next layer. Signals in turn are surprisingly simple, being usually just real numbers with weights which are “learned” by the system as it compares its final outputs against desired reality.

These simply neural nets are able to solve surprisingly complex problems and even mimic the behavior of biologically based complex systems such as brains.

However, there are still possibilities for improving and expanding the operation of the nodes, connections and signals of the low level physical

It would be preferable to provide an improved node capable of handling complex, even non-digital, inputs.

It would further be preferable to provide an improved node capable of handling improved signals which comprise entire functions rather than real numbers.

It would further be preferable to provide a method of neural net calculation using equations/functions rather than real numbers.

### SUMMARY OF THE INVENTION

### General Summary

The present invention teaches that the nodes of an artificial intelligence neural network may be wave form transistors which signal one another using functions as well as real numbers. The nodes then performs summing, or more accurately speaking a wide variety of functions, on the functions which they have received as input and then the output results (function) becomes the nodes signal to the next nodes in the net.

The present invention may be used with an arbitrary number of nodes arranged in an arbitrary number of layers.

Note that the system utilizes multi-variable functions (i.e. f(x₁, x₂, . . . xₙ) rather than f(x)), and in fact, multi-dimensional multi-variable functions, such as fig(x_{1.1}, x_{1.2}, . . . x_{1.n}, x_{2.n}, . . . x_{n.n})).

In addition to using functions as signals, the present invention teaches that the edges (connections) themselves may have function inputs influencing them, such that the function which is put into a connection (dendrite, synapse, edge, etc) may be altered during transmission in a way beyond merely being weighted or run through a function in the connection. That is, the external influence on the connection may itself be a second source of input function.

In addition, to implement the present computer architecture improvement teaches an individual transistor equivalent unit, the wave form transistor, which may be used to implement the computer architecture of the invention.

The wave form transistor may be implemented in various ways such as electronic architecture, fluid flows both compressible and non-compressible, mechanical devices and so forth. The electronic version of the wave form transistor (the presently preferred embodiment and best mode now contemplated) features multiple input leads which are under the influence of electro-magnets. The electro-magnet may have as its input another function, which in turn alters the function passing through the lead.

### Summary in Reference to Claims

It is therefore another aspect, advantage, objective and embodiment of the invention, in addition to those discussed previously, to provide a method of improving the operation of a neural net computing device having an arbitrary number of nodes arranged in an arbitrary number of layers, the method comprising the steps of:

providing first, second and third nodes;

providing a first connection from the first node to the third node;

providing a second connection from the second node to the third node;

signaling a first multi-variant function from the first node to the third node;

signaling a second multi-variant function from the second node to the third node;

summing the first and second multi-variant functions at the third node.

It is therefore another aspect, advantage, objective and embodiment of the invention, in addition to those discussed previously, to provide a method of improving the operation of a neural net computing device, further comprising:

providing a first signal field generator operative to alter a signal from the first node to the third node;

signaling a third multi-variant function to the first signal field generator.

It is therefore another aspect, advantage, objective and embodiment of the invention, in addition to those discussed previously, to provide a neural net comprising:

first, second and third nodes;

a first connection from the first node to the third node, the first connection operative to carry a first signal from the first node to the third node, the first signal comprising a first multi-variant function;

a second connection from the second node to the third node, the second connection operative to carry a second signal from the second node to the third node, the second signal comprising a second multi-variant function;

the third node operative to sum the first and second multi-variant functions.

It is therefore another aspect, advantage, objective and embodiment of the invention, in addition to those discussed previously, to provide a neural net, further comprising: a third signal;

a first signal field generator carrying the third signal;

the first connection operative in response to the first signal field generator to alter the first signal as it is carried from the first node to the third node.

It is therefore another aspect, advantage, objective and embodiment of the invention, in addition to those discussed previously, to provide a neural net, wherein:

the first and second connections are electronic connections;

the first, second and third nodes are artificial neurons;

the first signal field generator being a magnetic field generator.

It is therefore another aspect, advantage, objective and embodiment of the invention, in addition to those discussed previously, to provide an electronic device comprising: an electrically conductive substrate;

a plurality of electrically conductive input leads to the electrically conductive substrate;

a plurality of electrically conductive output leads from the electrically conductive substrate;

and a plurality of electro-magnets, each electro-magnet having a first state in which it projects magnetic flux across at least one of the plurality of electrically conductive input leads at a strength sufficient to alter a flow of an electron in the at least one electrically conductive input lead, and a second state in which it does not alter the flow of the electron in the at least one electrically conductive input lead.

It is therefore another aspect, objective, advantage and embodiment of the present invention, in addition to the discussed previously, to provide neural net comprising:

first, second and third nodes;

a first connection from the first node to the third node, the first connection operative to carry a first signal from the first node to the third node, the first signal comprising a first multi-variant function;

a second connection from the second node to the third node, the second connection operative to carry a second signal from the second node to the third node, the second signal comprising a second multi-variant function;

the third node operative to sum the first and second multi-variant functions into a first resultant multi-variant function.

It is therefore another aspect, objective, advantage and embodiment of the present invention, in addition to the discussed previously, to provide neural net comprising:

a third signal;

a first signal field generator carrying the third signal;

the first connection operative in response to the first signal field generator to alter the first signal as it is carried from the first node to the third node.

It is therefore another aspect, objective, advantage and embodiment of the present invention, in addition to the discussed previously, to provide neural net comprising:

a fourth signal;

a second signal field generator carrying the fourth signal;

the second connection operative in response to the second signal field generator to alter the second signal as it is carried from the second node to the third node.

It is therefore another aspect, objective, advantage and embodiment of the present invention, in addition to the discussed previously, to provide neural net comprising:

fourth, fifth, sixth and seventh nodes;

the first, second, fourth and fifth nodes being located in a first layer of the neural net;

the third and sixth nodes located in a second layer of the neural net;

the seventh node being located in a third layer of the neural net;

a third connection from the fourth node to the sixth node, the third connection operative to carry a fifth signal from the fourth node to the sixth node, the fifth signal comprising a third multi-variant function;

a fourth connection from the fifth node to the sixth node, the fourth connection operative to carry a sixth signal from the fifth node to the sixth node, the sixth signal comprising a fourth multi-variant function;

the sixth node operative to sum the fifth and sixth multi-variant functions into a second resultant multi-variant function;

a seventh signal;

a third signal field generator carrying the seventh signal;

the third connection operative in response to the third signal field generator to alter the fifth signal as it is carried from the fourth node to the sixth node;

an eighth signal;

a fourth signal field generator carrying the eighth signal;

the fourth connection operative in response to the fourth signal field generator to alter the sixth signal as it is carried from the fifth node to the sixth node;

a fifth connection from the fourth node to the sixth node, the third connection operative to carry a fifth signal from the fourth node to the sixth node, the fifth signal comprising a third multi-variant function;

a fourth connection from the fifth node to the sixth node, the fourth connection operative to carry a sixth signal from the fifth node to the sixth node, the sixth signal comprising a fourth multi-variant function;

a fifth connection from the third node to the seventh node, the fifth connection operative to carry a ninth signal from the third node to the seventh node, the ninth signal comprising the first resultant multi-variant function;

a sixth connection from the sixth node to the seventh node, the sixth connection operative to carry a tenth signal from the sixth node to the seventh node, the tenth signal comprising the second resultant multi-variant function;

the seventh node operative to sum the first and second resultant multi-variant functions into a third resultant multi-variant function; an eleventh signal;

a fifth signal field generator carrying the eleventh signal;

the fifth connection operative in response to the fifth signal field generator to alter the ninth signal as it is carried from the third node to the seventh node;

a twelfth signal;

a sixth signal field generator carrying the twelfth signal;

the sixth connection operative in response to the sixth signal field generator to alter the tenth signal as it is carried from the sixth node to the seventh node.

It is therefore another aspect, objective, advantage and embodiment of the present invention, in addition to the discussed previously, to provide neural net wherein the third, fourth, seventh and eighth signals are themselves multi-variant functions.

It is therefore another aspect, objective, advantage and embodiment of the present invention, in addition to the discussed previously, to provide neural net wherein: the first through sixth signal field generators general a vector field operative to influence the first through sixth connections.

It is therefore another aspect, objective, advantage and embodiment of the present invention, in addition to the discussed previously, to provide neural net wherein:

the vector field is a magnetic field;

the first through sixth connections are electronic connections;

the first through seventh nodes are artificial neurons;

the first through sixth signal field generators being magnetic field generators.

It is therefore another aspect, objective, advantage and embodiment of the present invention, in addition to the discussed previously, to provide neural net wherein:

the vector field is one member selected from the group consisting of: a light field, a sound field, an electrical field, a gravitational field, and combinations thereof.

### BRIEF DESCRIPTION OF THE DRAWINGS

FIG. 1 is an overview block diagram of a small number of nodes a PRIOR ART artificial intelligence system.

FIG. 2 is an overview block diagram of a small number of nodes of a first embodiment of the present invention.

FIG. 3 is an overview block diagram of a small number of nodes of a second embodiment of the invention, a first example of the invention in use.

FIG. 4 is an overview block diagram of a subset of the nodes of the second embodiment (first example) of the invention in use.

FIG. 5 is an overview block diagram of a subset of the nodes of the second embodiment (first example) of the invention in use.

FIG. 6 is an overview block diagram of a subset of the nodes of the second embodiment (first example) of the invention in use.

FIG. 7 is an overview block diagram of a single wave form transistor of a third embodiment of the invention, without control input from a magnetic inducer.

FIG. 8 is an overview block diagram of a single wave form transistor of the third embodiment of the invention, showing control input in the form of flux lines from a magnetic inducer.

FIG. 9 is a perspective elevational side view of a single wave form transistor according to a fourth embodiment of the invention, showing larger numbers of control inputs and outputs.

FIG. 10 is a vastly simplified block diagram of a slightly more complete neural network, similar to claims 3 through 6, using the simple wave form transistor of FIG. 8, showing with simple abbreviations the flow of signals 1 through 12 the various components of the simplified network.

FIG. 11 is an overview block diagram of a small number of nodes of a fifth embodiment of the invention, another example of the invention in use with analog or analytical multi-variant functions.

FIG. 12 is an overview block diagram of a subset of the nodes of the fifth embodiment of the invention in use.

FIG. 13 is an overview block diagram of a subset of the nodes of the fifth embodiment of the invention in use.

FIG. 14 is an overview block diagram of a subset of the nodes of the fifth embodiment of the invention in use.

### INDEX TO REFERENCE NUMERALS

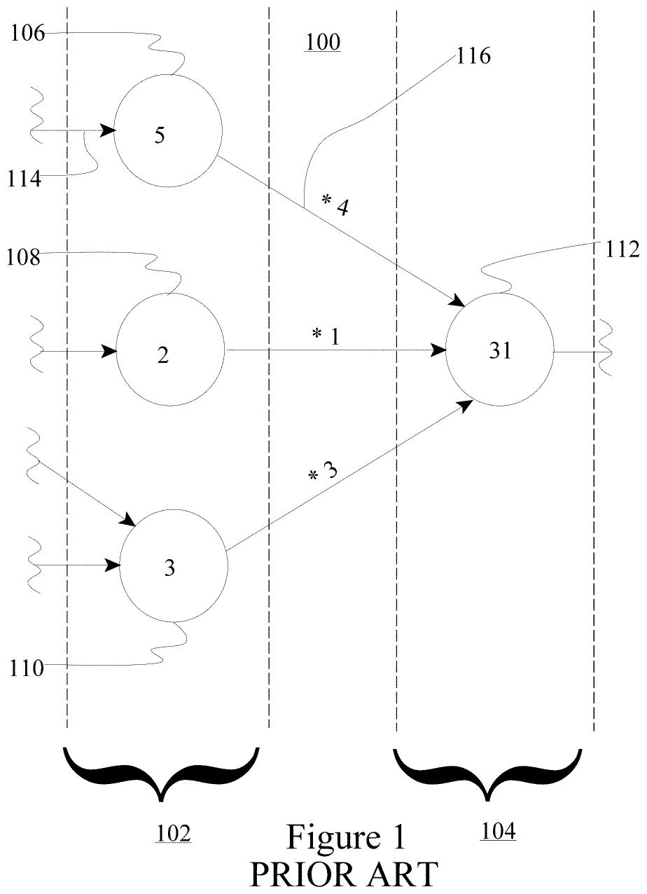

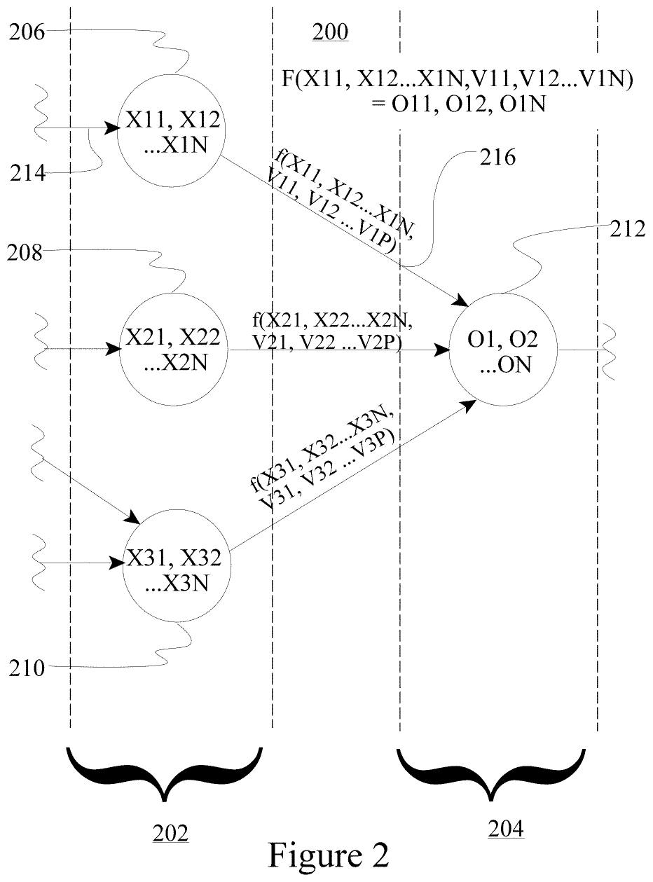

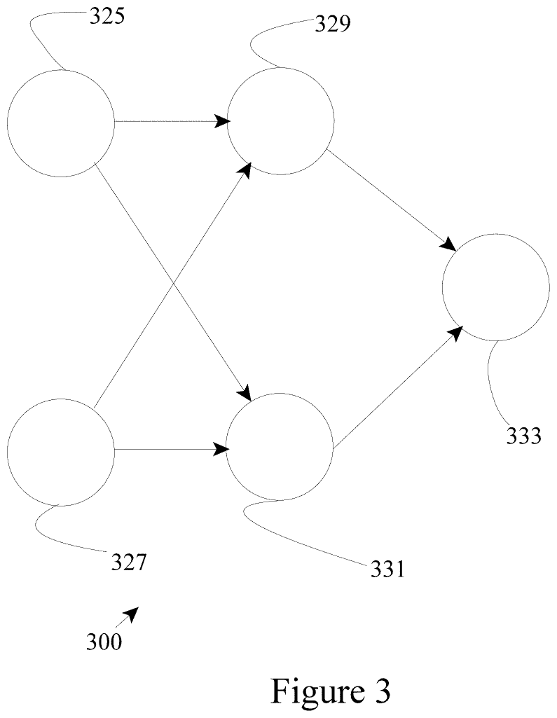

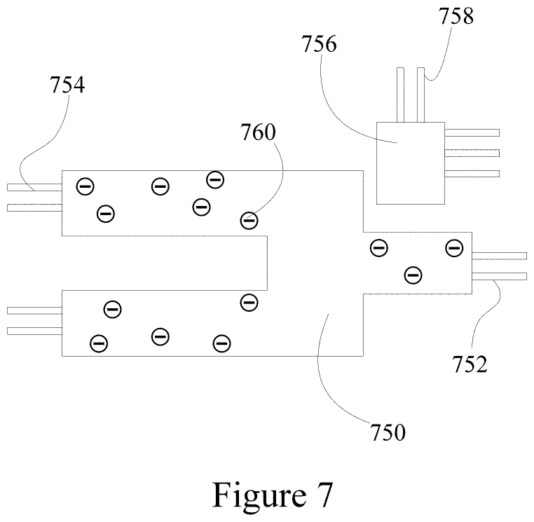

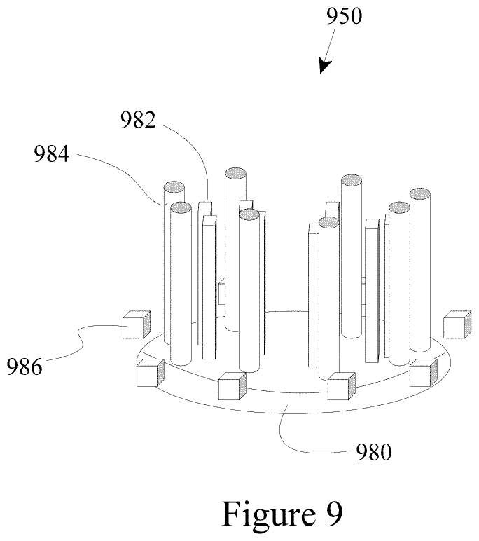

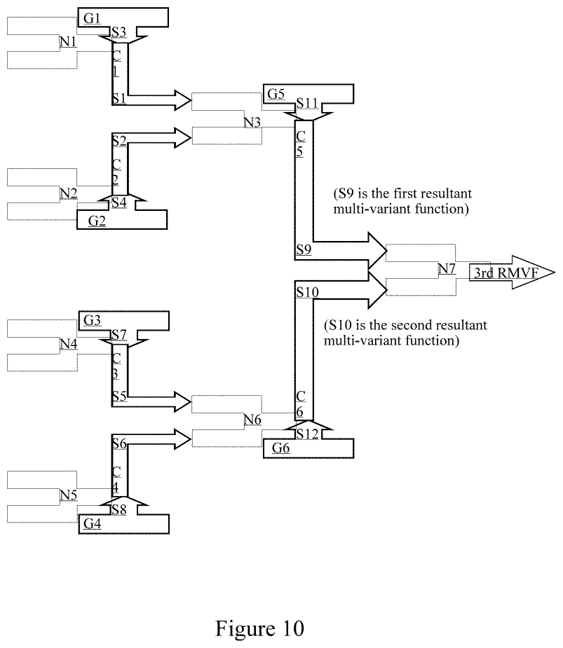

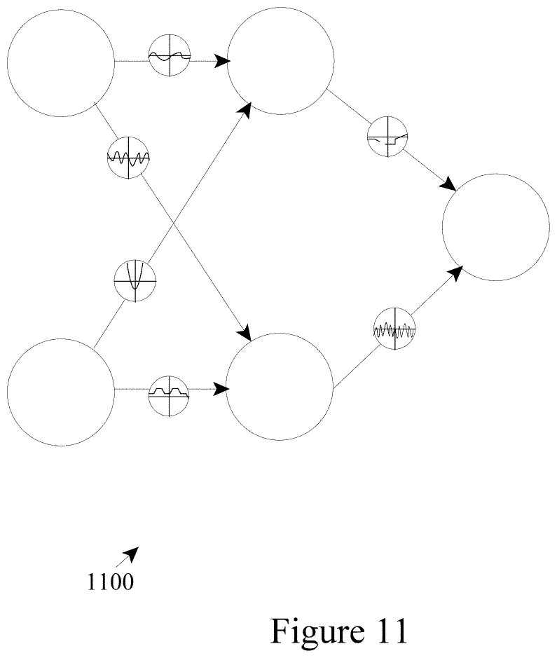

FIG. 1:
PRIOR ART A1 network 100
PRIOR ART first layer 102
PRIOR ART second layer 104
PRIOR ART first node 106
PRIOR ART second node 108
PRIOR ART third node 110
PRIOR ART fourth node in second layer 112
PRIOR ART input to first layer 114
PRIOR ART input from first layer to second layer 116
FIG. 2:
A1 network 200
Second layer 204
First node 206
Second node 208
Third node 210
Fourth node in second layer 212
Input to first layer 214
Input from first layer to second layer 216
FIGS. 3-6:
A1 network 300
First node 325
Second node 327
Third node 329
Fourth node 331
Fifth node 333
FIGS. 7 & 8:
Simple wave form transistor 750
First input connection 752
First output connection 754
Magnetic field generator
Electron 760
Electron being influenced 762
Magnetic flux 764
FIG. 9:
Wave form transistor 950
Substrate 980
First input 982
First output 984
First magnetic inducer (input) 986
FIG. 10:
Nodes 1 through 7 N1-N7
Connections 1 through 6 C1-C6
Field generators 1 through 6 G1-G6
Signals 1 through 12 S1-S12
Resultant multi-variant functions RMVF
FIGS. 11-14:
Neural network 1100

### DETAILED DESCRIPTION

Glossary

A node as defined herein refers to an artificial neuron, however, other than in reference to the prior art, the node is of a new type as indicated in the attached claims and the claims to follow in the utility applications later. This node has the capacity to handle non-digital inputs, multiple inputs, and in particular, multi-dimensional multi-variable functions as inputs and outputs.

The present invention may be used with an arbitrary number of nodes arranged in an arbitrary number of layers.

A connection as used herein refers to the signal carrying device between two nodes, which may be unidirectional or bidirectional. This may be a dendrite, pipe, bandwidth, network, an edge (as the term is used in the AI field), synapse (as used in biology and computer science), etc, however, the connection is unique in being under the influence of a second new type of input device, one which alters the signal as it is being transmitted and in ways other than mere weighting.

A signal as defined herein refers to a function rather than a simple weighted real number.

A vector field as used herein may be a field which can be handled as a plurality of vectors, the vectors indicating strength and direction of the field, and in addition, the vector field having the property of influencing flows through the field and/or flows through connections through the field. The vector field may be a magnetic field, an electrical field, a light field, gravitational field, a sound field or combinations thereof, or other later developed fields.

A magnetic field as used herein may be considered to be either a B field (magnetic flux density, induction, etc) or an H field (magnetic field intensity, strength, etc), and in general will be related, depending upon properties desired or required by a given signal, materials used by different components, etc.

End Glossary

FIG. 1 is an overview block diagram of a small number of nodes a PRIOR ART artificial intelligence system. PRIOR ART A1 network 100 has a first layer 102 and a second layer 104. First layer 102 has therein PRIOR ART first node 106, second node 108 and third node 110, while second layer 104 has therein PRIOR ART fourth node 112.

These are prior art nodes having the ability to perform simple operations such as summing on the basis of real number inputs from their edges or connections.

Edges/connections may be seen on FIG. 1 as numbers beside the arrows which connect the node circles. Obviously, these are simply real numbers and weights. PRIOR ART input to first layer 114 and PRIOR ART input from first layer to second layer 116 are examples of these simple signals.

FIG. 2 is an overview block diagram of a small number of nodes of a first embodiment of the present invention. A simple equation is shown as an example of the functions which the invention may carry as signals and operations.

$$f ( {X}_{1} , {X}_{2} , {X}_{N} , {V}_{1} , {V}_{2} , {V}_{N} ) = \begin{matrix}{0}_{1} \\ {0}_{2} \\ {0}_{3}\end{matrix} \qquad EQ . 1$$

A1 network 200 has a first layer 202, second layer 204 and within them first node 206, second node 208, third node 210 and fourth node 212 (in the second layer 204).

Input to first layer 214 and the output from the first layer 202 which is the input to the second layer 204 may be seen: 216.

This structure has a notable difference from the previous structure: the inputs/outputs are in fact functions such as the ones depicted.

Thus, the structure, simple as it is, has a unique ability to transmit, operate upon, and generate results, which are functions and carry a great deal more significance than mere real numbers.

Note that the diagrams presented are merely exemplary. Other functions may be used, different arrangements of edges/connections and so on. The present invention may be used with an arbitrary number of nodes arranged in an arbitrary number of layers. In fact, it is important to remember that EQ. 1 (and EQ. 2 below) may be physical devices and that this is just a mathematical representation.

FIG. 3 is an overview block diagram of a small number of nodes of a second embodiment of the invention, a first example of the invention in use. A somewhat more complex equation is shown as an example function:

$$f ( {x}_{1} , {x}_{2} , {v}_{1} , {v}_{2} ) = [ \begin{matrix}{0}_{1} = sin ( {x}_{1} * {v}_{1} ) + cos ( {x}_{2} * {v}_{2} ) \\ {0}_{2} = cos ( {x}_{1} * {v}_{1} ) + sin ( {x}_{2} * {v}_{2} )\end{matrix} ] \qquad EQ . 2$$

A1 network 300 has a first node 325, second node 327, third node 329, fourth node 331 and fifth node 333. These are arranged in layers, with interconnections (edges) shown by arrows.

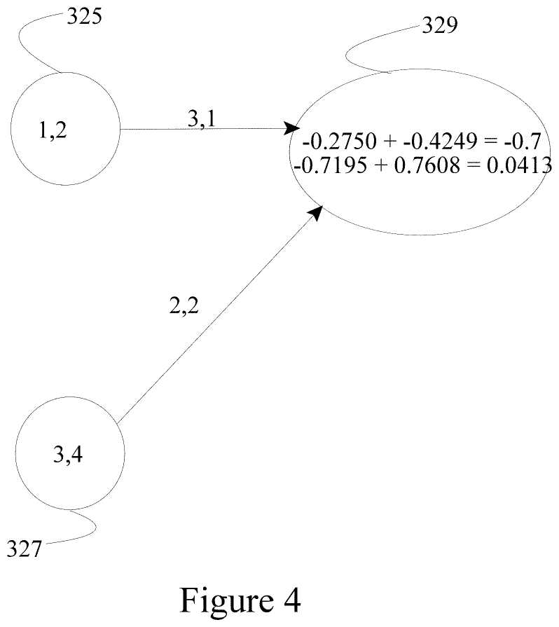

FIG. 4 is an overview block diagram of a subset of the nodes of the second embodiment (first example) of the invention in use.

In this figure, nodes 325 and 327 are shown signaling to node 329. However, the signals are shown processed by the node 329 according to Eq. 2 above.

It may immediately be seen that this means each node is sending 2 variables, not one, in its output signals. These numbers are then weighted as is known in the art (for example the connection from node 325 to node 329 weights the two variables by 3 times and 1 time), and then node 329 processes per Equation 2. Node 329 also processes the weighted numbers from node 327.

Since these are multi-variant signals, the weights from each node are added in a matrix/ array style to get the outputs of node 329.

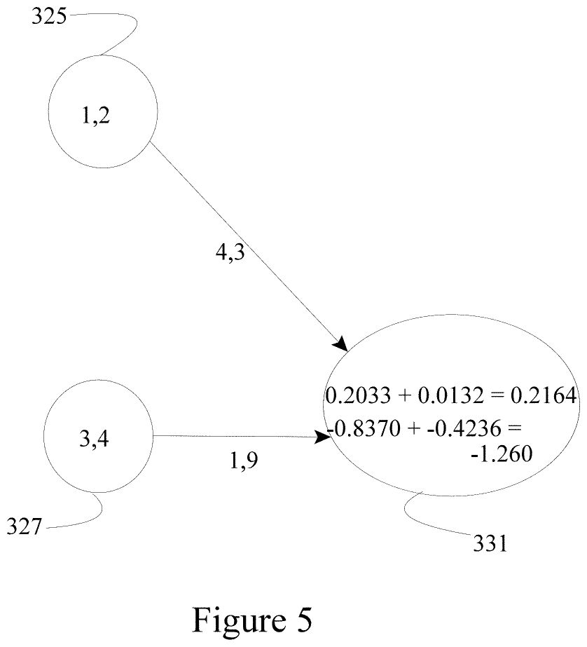

FIG. 5 is an overview block diagram of a subset of the nodes of the second embodiment (first example) of the invention in use. Once again, the outputs from nodes 325 and 327 (which are the same as from the previous FIG. 4) are fed through the weights of their connections (4,3 and 1,9) before reaching node 331, which uses Eq. 2 for processing, adds the two sets of results in array form (that is, adds the first result from node 325 to the first result from node 327, then adds the second result from node 325 to the second result from node 327), and thus derives it's own output numbers: 0.2164 and −1.260.

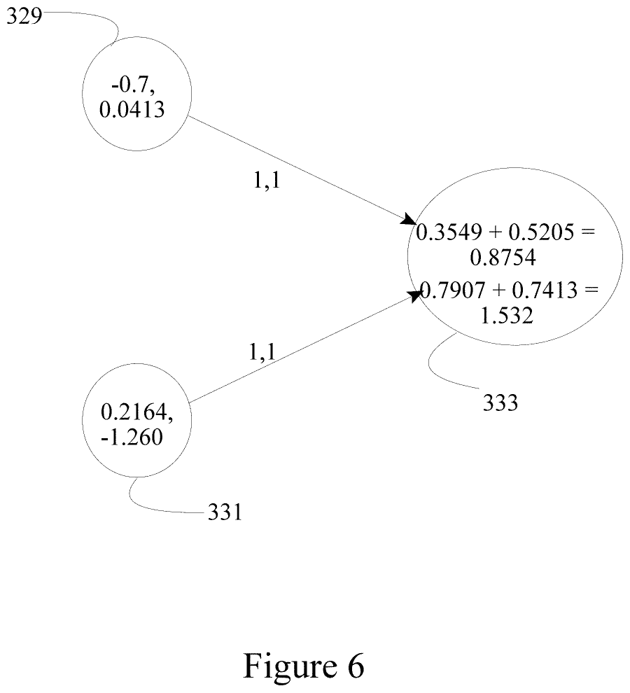

FIG. 6 is an overview block diagram of a subset of the nodes of the second embodiment (first example) of the invention in use. In this diagram of the same example, the numbers output from nodes 329 and 331 are now the input numbers (signals) to node 333. For clarity we weight these values at 1,1 and 1,1 and then perform the operations of Eq. 2 above, sum in array form, and get the output numbers (08.754 and 1.532) for node 333. Node 333 may be signaling another deeper layer or it may be an output function.

In this case, we'll assume that the node 333 is providing a final result and so backward propagation is next employed to improve the neural net's functioning. For example, an objective function of 1,1 the next iteration of the system backwards might try as a guess F(0.2164, −1.260, 1.01, 1) and calculate results, then try F(0.2164, −1.260, 1, 1.01), calculate results, select the more successful guess (the former guess, abandoning the latter), so the system might next try F(0.2164, −1.260, 1, 0.99), find an even better result, keep that result, and so work backwards through the system, altering values as it goes.

FIG. 7 is an overview block diagram of a single wave form transistor of a third embodiment of the invention, without control input from a magnetic inducer.

This is an electronic embodiment of the device, though the claims cover embodiments which are non-electronic as well. Electrons (which may be regarded as voltage differences between different points) are depicted as small unitary circles.

Simple wave form transistor 750 has only two major branches for output and one major branch for input. The first input connection 752 may be seen on the input branch, while the first output connection 754 may be seen on the upper (as seen in FIG. 7) of the two output branches. In this simple WFT, there are only two leads for input and four for output.
The device is made of conductive materials such as a ferrous metal. Magnetic field generator 756 has five magnetic field input connections such as first lead 758. Note that electron 760 (and associated voltage differences) is not being influenced by the magnetic source 756, as it is in a state of generating little or no magnetic flux.

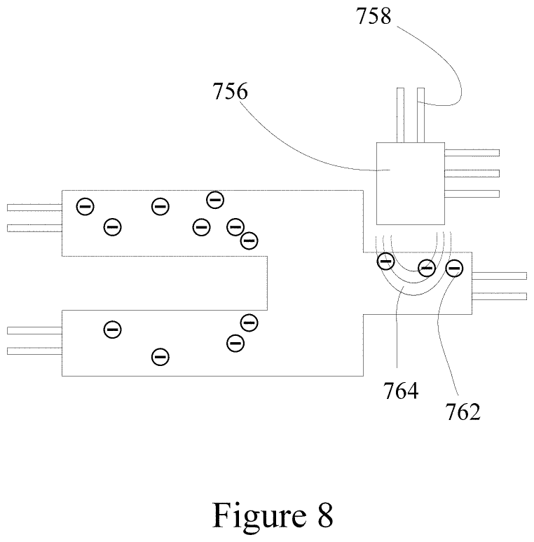

On the other hand FIG. 8 is an overview block diagram of a single wave form transistor of the third embodiment of the invention, showing control input in the form of flux lines from a magnetic inducer: electron 762 IS being influenced by magnetic flux 764. It may be seen that voltage differences and flow patterns all through the wave form transistor (WFT) are being altered.

This simple embodiment has been built and tested as a proof of concept demonstrator, and has shown that the basic principle works as expected.

FIG. 9 is a perspective elevational side view of a single wave form transistor according to a fourth embodiment of the invention, showing larger numbers of control inputs and outputs.

This version of a wave form transistor 950 is much more capable than the proof of concept model. It can handle a number of inputs (8 in this case), and an equivalent number of outputs, as well as 8 more inputs derived from 8 magnetic field inducers located around the periphery of substrate 980.

First input 982 is near to first output 984 but in fact, the inputs and outputs are all connected by substrate 980 and thus the final output is a function of the entire set of input signals as well as the function embodied in the shape and spacing of the device itself.

First magnetic inducer (input) 986 is shown in a position in which it largely influences with a second input signal the output signal of lead 984, but it may readily be observed that in fact it will influence the other inputs or outputs as well.

Thus in the same manner that first input lead 758 will have a signal which impacts the signal received from first input lead 752, so too the signal from 986 will alter the signal in 982 and/or 984 or other leads.

FIG. 10 is a vastly simplified block diagram of a slightly more complete neural network, using the simple wave form transistor of FIG. 8, (if the more complex embodiment of FIG. 9 were used, the network would be quickly impossible to diagram). This drawing omits one or more outputs from the WFT (wave form transistors), but shows with simple abbreviations the flow of signals 1 through 12 the various components of the simplified network: nodes 1 through 7 (reference numerals N1-N7), connections 1 through 6 (C1-C6), field generators 1 through 6 (G1-G6), signals 1 through 12 (S1-S12, within other components), and three resultant multi-variant functions (1^{st}, 2^{nd} and 3^{rd} RMVF, however, the 1^{st} and 2^{nd} RMVF are also signals 11 and 12 (S11 and S12) and using both abbreviations might cause confusion.

Outputs going to nodes outside this narrowing pyramid are omitted, as are nodes outside the inverted pyramid. In reality, in testing the nodes of this embodiment had two outputs going to two different nodes.

Reading claims three through ten may be aided by referring to this diagram, which is somewhat similar and is greatly simplified.

It may be seen that node 1 and node 2 (N1 and N2) send signals via connections 1 and 2 (C1 and C2). Signals 1 and 2 (S1 and S2) are depicted within the connections through which they travel, but the signal is of course not the connection. S1 and S2 are altered in transit through Cl and C2 because field generators G1 and G2 alter S1 and S2 through their vector fields. G1 is thus altering S1 by function S3, meaning that Si arrives at node 3 (N3, in the second layer) as a different function than it set out.

Note that the functions do NOT have to be in a time domain, nor analog. The function may be transmitted analytically (for example, “F(x) =3y+5z”) or digitally as discussed previously, or analog, but regardless, the function need not be a signal which varies with time.

Node three (N3) receives not only altered 51 but also an altered S2 from N2 (node 2).

N3 then combines these signals under the influence of G5, which has signal 11 (S11) influencing N3 and/or C5 operations, and thus altering signal S9 which goes to N7 (node 7) the final node shown, the only node of the third layer shown.

It will be appreciated that nodes 4 and 5 are going through a similar process with regard to node 6, which in turn processes signals and passes them to node 7.

In reality, back propagation, larger numbers of inputs and outputs and a much large neural net are used in larger embodiments. It is possible that there might be more interconnections even between the nodes shown, for example, node 5 (N5) might have its second connection running to node 3 (N3), or to N1, or directly to N7. (To repeat, this is a simplified network using one of the earlier models of wave form transistor created by the inventor, the large “Y” shaped model which uses electrical transmission and magnetic influence.)

FIG. 11 is an overview block diagram of a small number of nodes of a fifth embodiment of the invention, another example of the invention in use with analog or analytical multi-variant functions. In this case, the functions are depicted with a visual representation, that is, showing that the device may be analog in nature, and may in fact operate using analytical functions, that is, functions expressed in the familiar language of mathematics.

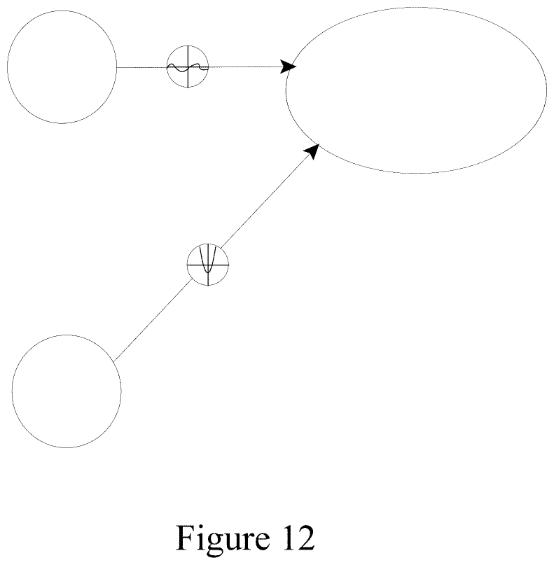

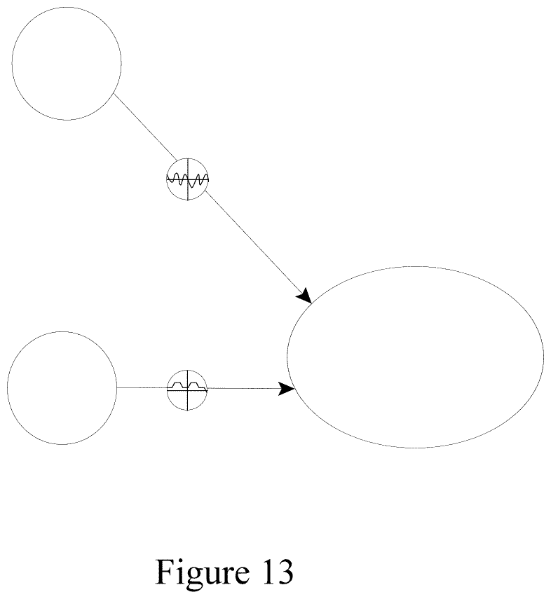

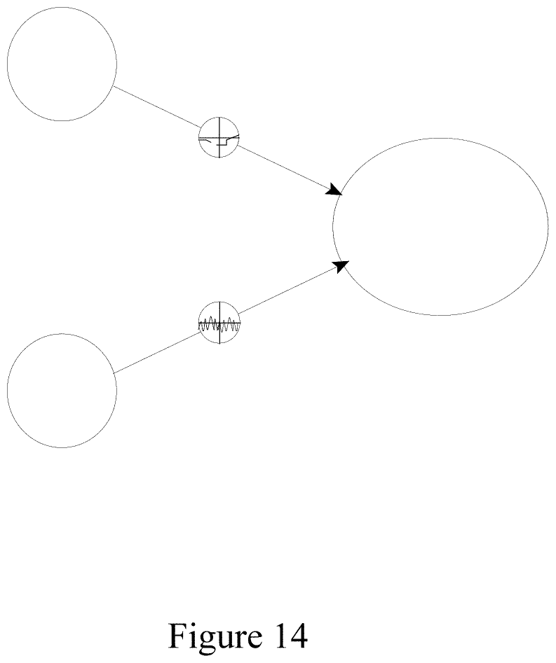

FIG. 12 is an overview block diagram of a subset of the nodes of the fifth embodiment of the invention in use, while FIG. 13 is an overview block diagram of a subset of the nodes sending different functions to different nodes in later layers. Then in FIG. 14 is an overview block diagram of the final (2^{nd} to 3^{rd} layer subset of the nodes) function transmission. This set of views is vastly simplified, omitting numerous components and even function inputs in order to provide a simple graphical comprehension of one aspect of the invention: signals in a neural net may be multi-variant functions, even multi-variant functions in an instantaneous (non-time) domain.

Note that the invention may actually be designed/developed in larger and more complex embodiments by building an initial simulation of an area. Then machine learning can be utilized in an iterative manner, with back propagation, to take desired outputs and use those outputs to obtain the necessary inputs, followed by finding the intersection of the desired outputs with proper inputs and then implementing the wave form transistor. However the device as built is a hardware implementation at this time.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A method of improving the operation of a neural net computing device having an arbitrary number of nodes arranged in an arbitrary number of layers, the method comprising the steps of:
providing first, second and third nodes;
providing a first connection from the first node to the third node;
providing a second connection from the second node to the third node;
signaling a first multi-variant function from the first node to the third node;
signaling a second multi-variant function from the second node to the third node;
summing the first and second multi-variant functions at the third node.

2. The method of claim 1, further comprising:
providing a first signal field generator operative to alter a signal from the first node to the third node;
signaling a third multi-variant function to the first signal field generator.

3. A neural net comprising:
first, second and third nodes;
a first connection from the first node to the third node, the first connection operative to carry a first signal from the first node to the third node, the first signal comprising a first multi-variant function;
a second connection from the second node to the third node, the second connection operative to carry a second signal from the second node to the third node, the second signal comprising a second multi-variant function;
the third node operative to sum the first and second multi-variant functions into a first resultant multi-variant function.

4. The neural net of claim 3, further comprising:
a third signal;
a first signal field generator carrying the third signal;
the first connection operative in response to the first signal field generator to alter the first signal as it is carried from the first node to the third node.

5. The neural net of claim 4, further comprising:
a fourth signal;
a second signal field generator carrying the fourth signal;
the second connection operative in response to the second signal field generator to alter the second signal as it is carried from the second node to the third node.

6. The neural net of claim 5, further comprising:
fourth, fifth, sixth and seventh nodes;
the first, second, fourth and fifth nodes being located in a first layer of the neural net;
the third and sixth nodes located in a second layer of the neural net;
the seventh node being located in a third layer of the neural net;
a third connection from the fourth node to the sixth node, the third connection operative to carry a fifth signal from the fourth node to the sixth node, the fifth signal comprising a third multi-variant function;
a fourth connection from the fifth node to the sixth node, the fourth connection operative to carry a sixth signal from the fifth node to the sixth node, the sixth signal comprising a fourth multi-variant function;
the sixth node operative to sum the fifth and sixth multi-variant functions into a second resultant multi-variant function;
a seventh signal;
a third signal field generator carrying the seventh signal;
the third connection operative in response to the third signal field generator to alter the fifth signal as it is carried from the fourth node to the sixth node;
an eighth signal;
a fourth signal field generator carrying the eighth signal;
the fourth connection operative in response to the fourth signal field generator to alter the sixth signal as it is carried from the fifth node to the sixth node;
a fifth connection from the third node to the seventh node, the fifth connection operative to carry a ninth signal from the third node to the seventh node, the ninth signal comprising the first resultant multi-variant function;
a sixth connection from the sixth node to the seventh node, the sixth connection operative to carry a tenth signal from the sixth node to the seventh node, the tenth signal comprising the second resultant multi-variant function;
the seventh node operative to sum the first and second resultant multi-variant functions into a third resultant multi-variant function;
an eleventh signal;
a fifth signal field generator carrying the eleventh signal;
the fifth connection operative in response to the fifth signal field generator to alter the ninth signal as it is carried from the third node to the seventh node;
a twelfth signal;
a sixth signal field generator carrying the twelfth signal;
the sixth connection operative in response to the sixth signal field generator to alter the tenth signal as it is carried from the sixth node to the seventh node.

7. The neural net of claim 6, wherein the third, fourth, seventh and eighth signals are themselves multi-variant functions.

8. The neural net of claim 7, wherein:
the first through sixth signal field generators general a vector field operative to influence the first through sixth connections.

9. The neural net of claim 8, wherein:
the vector field is a magnetic field;
the first through sixth connections are electronic connections;
the first through seventh nodes are artificial neurons;
the first through sixth signal field generators being magnetic field generators.

10. The neural net of claim 8, wherein:
the vector field is one member selected from the group consisting of: a light field, a sound field, an electrical field, a gravitational field, and combinations thereof.

11. An electronic device comprising:
an electrically conductive substrate;
a plurality of electrically conductive input leads to the electrically conductive substrate;
a plurality of electrically conductive output leads from the electrically conductive substrate;
and a plurality of electro-magnets, each electro-magnet having a first state in which it projects magnetic flux across at least one of the plurality of electrically conductive input leads at a strength sufficient to alter a flow of an electron in the at least one electrically conductive input lead, and a second state in which it does not alter the flow of the electron in the at least one electrically conductive input lead.
